(19) United States
(12) Patent Application Publication
(10) Pub. No.: US 2021/0299671 A1
(43) Pub. Date: Sep. 30, 2021

(54) PLATE FOR SAMPLING APPARATUS AND MICROCENTRIFUGE VIAL FOR MICROSAMPLING APPARATUS

(71) Applicant: QUEST DIAGNOSTICS INVESTMENTS LLC, Secaucus, NJ (US)

(72) Inventors: Thomas C. LYNN, Temecula, CA (US); Nikita GANESHAN, Irvine, CA (US)

(73) Assignee: QUEST DIAGNOSTICS INVESTMENTS LLC, Secaucus, NJ (US)

(21) Appl. No.: 17/269,927

(22) PCT Filed: Aug. 21, 2019
(86) PCT No.: PCT/US2019/047564

§ 371 Date: Feb. 19, 2021

Related U.S. Application Data
(60) Provisional application No. 62/721,590, filed on Aug. 22, 2018.

(51) Int. Cl. B01L 9/06; B01L 3/00; G01N 35/10

(52) U.S. Cl. CPC B01L 9/06; B01L 3/5082; B01L 2300/0832; B01L 2300/0609; G01N 35/1065

(57) ABSTRACT

An apparatus for use in biological sampling includes a plate configured for attachment to a sample rack. The plate comprising a plurality of openings extending therethrough that each have a non-circular shape that comprises a first portion and a second portion, the first portion having a smaller lateral dimension than the second portion. The smaller first portion is configured to facilitate removal of a sampling tip from a sampling device to allow for improved automation of the sampling analysis operation.

### CROSS-REFERENCE TO RELATED PATENT APPLICATIONS

The present application claims the benefit of and priority to U.S. Patent App. No. 62/721,590, filed Aug. 22, 2018, the entire disclosure of which, including the specification and drawings, is incorporated herein by reference in its entirety.

### BACKGROUND

The disclosed embodiments relate generally to biological specimen collection. In particular, the embodiments relate to a plate for a sampling apparatus and a microcentrifuge vial for a microsampling apparatus.

Traditional clinical diagnostics are performed using blood samples collected by phlebotomy in physician offices or phlebotomy centers. The sample volumes of blood collected by phlebotomy may be up to 10 milliliters.

Alternative sample types are of interest to potentially improve the patient experience and patient convenience. For example, microsampling is a procedure for obtaining and analyzing small biological samples (e.g., 100 microliters or less) for analysis. Microsampling may be performed via fingerstick collection by the patient in a remote location such as their home or office. Fingerstick collection involves pricking the finger of the patient with a needle, allowing a drop of blood to rise to the skin surface, and capturing the drop of blood in an absorbent tip of a testing device. The testing device is then sealed in a case and mailed without refrigeration or special handling to a laboratory for analysis. A full range of analytes may be tested using the small biological sample (e.g., molecular, small molecules, proteins, peptides, etc.). Although fingerstick collection is described in the example above, one of ordinary skill in the art would appreciate that small biological samples (microsamples) may be collected by other known approaches, provided the sample size is 100 microliters or less.

The sample volume required in microsampling may be as much as 500 to 1,000 times less than the sample volume required in traditional clinical diagnostics that are collected, for example, by phlebotomy. The reduced blood volumes collected in microsampling are advantageous, for example, for patients who undergo frequent testing for several analytes where anemia and/or iron deficiency can be a problem. Use of microsampling approaches may be desirable for individuals who fear or dislike phlembotomy, or for individuals with difficult venous access (e.g., young children, obese individuals, etc.). Microsampling also reduces the infrastructure costs associated with traditional diagnostic testing sample collection, which requires a physician office or phlebotomy center.

An example of a microsampling specimen collection device (i.e., a microsampler) is the Mitra® microsampler. Referring to FIG. 1, the Mitra® microsampler includes a barrel at a distal end thereof, a sampler body having ribs thereon, and an absorbent sampler tip at a proximal end thereof. The distal end fits a standard 20-200 microliter pipette head. The barrel can be labeled or written on to identify the source of a sample. The ribs of the sampler body prevent the sample from contacting walls of an extraction plate. The sampler tip includes a hydrophilic porous material that rapidly wicks fluid. The sampler tip collects, for example, 10 microliters or 20 microliters every time in a matter of seconds, regardless of the blood hematocrit level. The sample dries in 2 hours or less in ambient temperatures. Dried samples are not considered a biohazard, thereby eliminating the need for dry ice and special transportation and its associated costs.

Before being analyzed, the biological sample must be extracted from the microsampler. In general, a plurality of samples are processed in a single procedure (sequentially or simultaneously). For example, the samples may be processed in a conventional 96 well plate, each configured to receive one sample. As another example, a sample rack may include a plurality of wells that receive test tubes, each configured to receive one sample. Some sample racks may include up to 96 wells or test tubes such that up to 96 samples are processed. FIGS. 2A and 2B illustrate the Mitra® microsampler inserted into the Mitra® 96-Autorack. As seen in FIG. 3, a conventional sample rack is covered by a plate having a plurality of circular holes therein. An automatic sample handler, for example, a sample handler made by Hamilton, include 20-200 microliter pipette heads that may be programmed to automatically pipette a desired volume of solution (e.g., an extraction buffer, water, etc.) into each well or test tube.

In order to extract the sample, the sampler tip of each microsampler is placed in contact with an extraction buffer that is absorbed in the sampler tip. Next, each sampler tip must be manually removed from the microsampler in order to undergo additional extraction processing (e.g., shaking, heating, or cooling). It takes a long time to manually remove each sampler tip taking care to not contaminate the sample.

In the case of microsampling approaches, the volume of the acquired sample is less than or equal to 100 microliters. When the sampler tip is removed from the microsampler and placed in the bottom of a standard test tube (12 mm×75 mm), there are limitations regarding the type of lab equipment that may be used to recover the sample, obtain liquid from the bottom of the test tube, and analyze the recovered sample.

A need exists for improved technology, including technology that addresses the problems described above.

### SUMMARY

One exemplary embodiment relates to an apparatus for use in biological sampling. The apparatus includes a plate configured for attachment to a sample rack. The plate includes a plurality of openings extending therethrough, where the plurality of openings each have a non-circular shape that comprises a first portion and a second portion, the first portion having a smaller lateral dimension than the second portion.

According to some embodiments, each of the plurality of openings has a teardrop shape. According to other embodiments, each of the plurality of openings has a keyhole shape. According to still other embodiments, the first portion of the openings is a notched portion.

According to some embodiments, the each of the plurality of openings is configured to receive a sampling device therethrough and the first portion is configured to allow for separation of a sampler tip from the sampling device.

According to some embodiments, the sampling device is a microsampling specimen collection device.

According to some embodiments, the apparatus includes a sample rack, and the plate is coupled to the sample rack.

According to some embodiments, the sample rack is configured to hold a plurality of test tubes that are aligned with the plurality of openings in the plate.

According to some embodiments, a microcentrifuge vial is included that comprises a base and a protrusion extending from the base, where the base is configured for securing the microcentrifuge vial to a test tube. According to some embodiments, an extension extends from the base that defines a channel in which an upper end of a test tube may be received to aid in securing the microcentrifuge vial to the test tube. According to some embodiments, the protrusion is hollow and is configured to receive a biological sample.

According to an exemplary embodiment, a method of extracting a biological sample from a sampling device utilizes an apparatus as recited any of the preceding paragraphs in this section. The method includes inserting at least a portion of a sampling device containing a biological sample through one of the plurality of openings in the plate, the sampling device comprising a sampler body and a sampler tip, wherein the sampler tip is beneath the plate following the insertion. The method also includes moving the sampling device laterally toward the first portion of the opening. The method also includes retracting the sampler body out of the opening to separate the sampler tip from the sampler body.

According to some embodiments, retracting the sampler body out of the opening causes at least a portion of the sampler tip to engage with the plate surrounding the first portion of the opening to cause separation of the sampler tip from the sampler body.

According to some embodiments, the method includes simultaneously performing the steps of the method for a plurality of sampling devices.

According to some embodiments, the method is performed using an automated sample handler.

It should be appreciated that any of the features described in this application may be used in other combinations and with other embodiments than those with which they are primarily described, and all such variations and modifications are intended as being within the scope of the present disclosure.

### BRIEF DESCRIPTION OF THE DRAWINGS

The disclosure will become more fully understood from the following detailed description, taken in conjunction with the accompanying figures, in which:

FIG. 1 illustrates the Mitra® microsampler, which may be used as a microsampler in conjunction with a microsampling apparatus.

FIGS. 2A and 2B illustrate the Mitra® microsampler inserted into the Mitra® 96-Autorack.

FIG. 3 illustrates an autorack in a Hamilton Multiflex Piercing Module.

FIG. 4A illustrates sampling apparatus configured for automated removal of a sampler tip from a sampling device according to an exemplary embodiment.

FIG. 4B illustrates the sampling apparatus of FIG. 4A having microsamplers therein.

FIG. 5 illustrates various views of a carrier plate of the microsampling apparatus of FIG. 4A having teardrop-shaped openings.

FIG. 6 illustrates various views of a carrier plate of the microsampling apparatus of FIG. 4A having keyhole-shaped openings.

FIG. 7 illustrates various examples of a microcentrifuge vial configured to receive a sampler tip of a microsampler.

FIG. 8 illustrates various views of a microcentrifuge vial having a pointed end.

FIG. 9 illustrates various views of a microcentrifuge vial having a rounded end.

FIG. 10 illustrates various views of a microcentrifuge vial having a rounded end, where sides of a protruding portions have a steeper slope than the microcentrifuge vial of FIG. 9.

FIG. 11 illustrates various views of a short microcentrifuge vial having a rounded end.

FIG. 12 illustrates various views of a short microcentrifuge vial having a rounded end, where sides of a protruding portions have a steeper slope than the microcentrifuge vial of FIG. 11. The microcentrifuge vial includes a lip configured to be attached to a test tube or tubular casing.

FIG. 13 illustrates various examples of a tubular casing and a microcentrifuge vial configured to be fixed thereto.

FIG. 14 illustrates additional examples of tubular casing and a microcentrifuge vial configured to be fixed thereto.

FIG. 15 illustrates various views of a tubular casing to which a microcentrifuge vial is configured to be fixed thereto.

FIG. 16 illustrates various views of a tubular casing having a rectangular aperture in the side thereof.

FIG. 17 illustrates an example method of loading a sample into the microsampling apparatus, extracting the sample, and analyzing the sample.

Any dimensions identified in the figures are non-limiting examples.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

In accordance with an exemplary embodiment, a sampling apparatus or system includes features that are intended to improve the automation of the sample analysis process, as well as allowing for enhanced functionality with respect to microsampling. According to one exemplary embodiment, a sampling rack utilizes a plate that includes a plurality of non-circular holes or openings that facilitate the removal of sampling tips from sampling devices that are used to procure biological samples. The non-circular holes or openings include a portion that has a dimension that is smaller than the sampling device and is configured to allow separation of the sampling tip from the sampling device. The plate may include any number of openings or holes, and in one particular embodiment, may include 96 such openings or holes so as to be compatible with standard sample racks used in the field.

The sampling apparatus or system may also utilize microcentrifuge vials that may be configured to couple to test tubes, vials, or other similar devices. The microcentrifuge vials have a configuration that is intended to allow for the capture or retention of relatively small volume biological samples, and are compatible with centrifuge or other analysis equipment. Once received within the microcentrifuge vial, the sample may be transported to a centrifuge or to other analysis equipment for analysis.

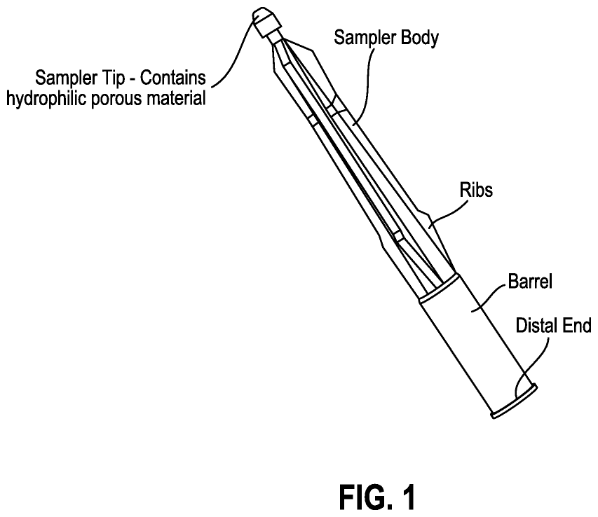

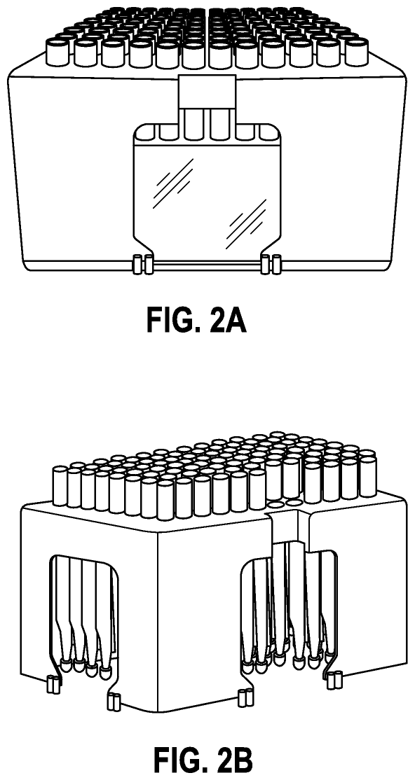

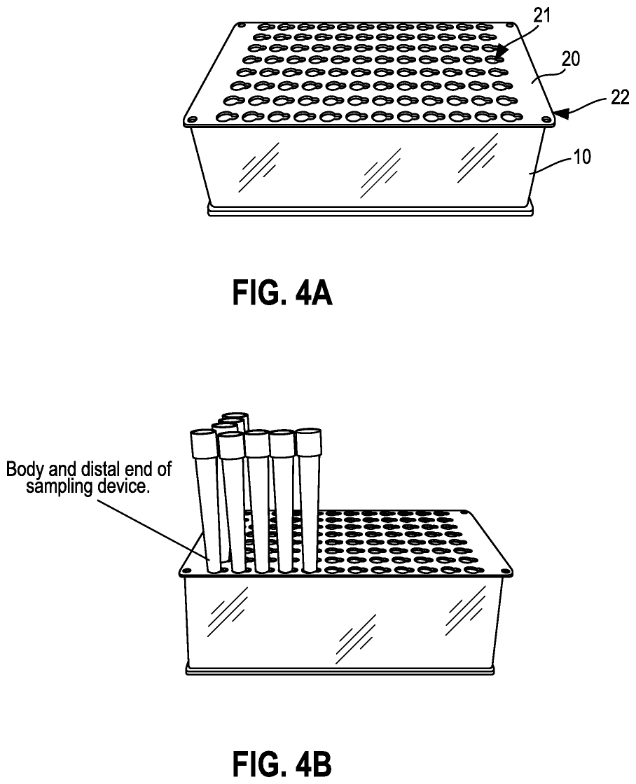

Turning now to FIGS. 4A, 4B, 5 and 6, a sample rack 10 (e.g., for receiving a plurality of test tubes or sample vials) may be used in conjunction with a plate 20 in an automated process for removing sampler tips from a sampling device (e.g., the Mitra® microsampler discussed above with respect to FIG. 1, although other types of sampling devices may be used according to other exemplary embodiments without departing from the spirt of the present disclosure, and the sampling device need not be a microsampling device).

Either or both of the sample rack 10 and the plate 20 can be produced by any suitable process using biocompatible materials that will not affect the analyte analysis. For example, the plate may be produced using additive manufacturing processes (e.g., 3D printing). Other production methods may also be used according to other exemplary embodiments. Alternatively, the plate 20 can be 3D printed (or produced by other processes) and fit to a commercially available sample rack such as that shown as sample rack 10.

As discussed above, the sample rack 10 can have a conventional 96-well configuration (see FIGS. 4A, 4B, 5 and 6) or may include one or more wells that receive test tubes (not illustrated). According to other exemplary embodiments, more or fewer wells may be utilized. As shown, the plate 20 includes a plurality of holes or openings 21 (shown as non-circular openings) extending through the plate, with each opening 21 intended to correspond to a well or test tube in the sample rack 10. For example, for a sample rack 10 that includes 96 wells or test tubes, the plate 20 would include 96 non-circular openings 21.

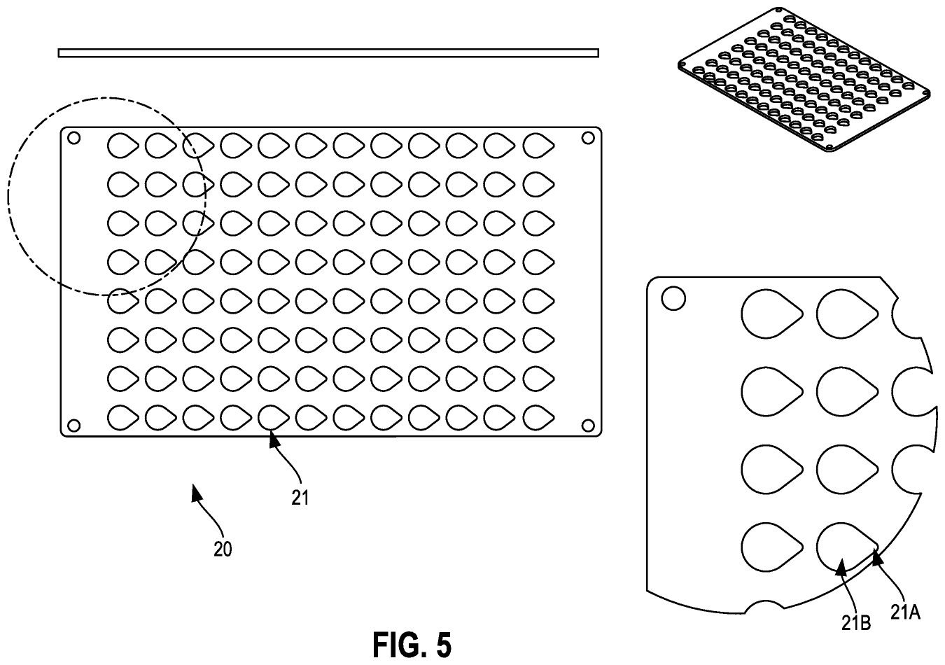

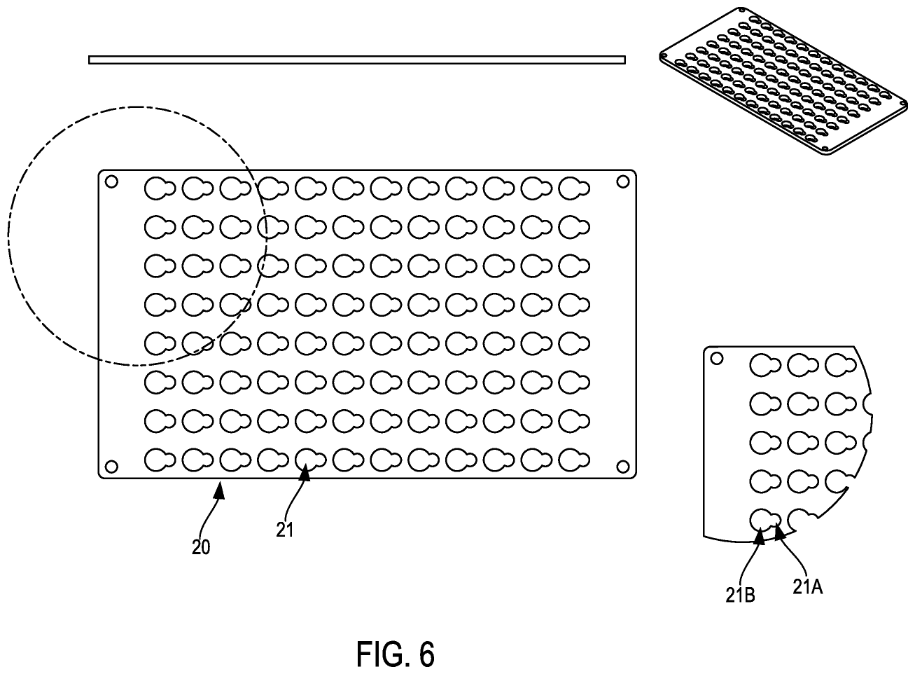

Each of the openings 21 is non-circular and has a first portion 21A (shown as a notched or reduced-area portion) and a second portion 21B (shown as a larger portion that has a generally circular shape adapted to allow a test tube or sample vial to be provided therethrough). For ease of reference, the first portion 21A will be referred to hereafter as “notched portion 21A” and the second portion 21B will be referred to as the “larger portion 21B” of the opening 21. The larger portion 21B has a larger lateral dimension as compared to the notched portion 21A. FIG. 5 illustrates an example in which the plate 20 has teardrop-shaped openings 21, in which the larger portion 21B is the larger portion of the teardrop, and the notched portion 21A is the smaller portion extending therefrom. FIG. 6 illustrates another example in which the plate 20 has keyhole-shaped openings 21 (again, the smaller portion of the keyhole shape would be considered to be the notched portion 21A and the larger portion of the keyhole shape would be considered to be the larger portion 21B). Although two configurations for the non-circular openings have been illustrated in FIGS. 5 and 6, it should be understood by those reviewing the present disclosure that other shapes are also possible without departing from the spirit of the concept disclosed herein, and that such configurations would be considered as falling within the scope of the present application.

The larger portions 21B are configured to receive the sampler tip, and the notched portions 21A are configured to assist in separating/removing the sampler tip containing a biological sample therein from the body of a sampling device, as will be described in more detail below.

The plate 20 is configured to attach to the sample rack 10, for example, via snap fit or by inserting fasteners in holes 22 provided in the plate 20. As illustrated in FIGS. 4A, 4B, 5 and 6, the holes 22 are located in corners of the plate 20. However, in other examples, the holes 22 may be located at different locations along a periphery of the plate 20.

In operation, the plate 20 is attached to the sample rack 10. One or more sampling devices, each having a sampler tip containing a biological sample, is inserted into the sample rack 10 (one microsampler per well or test tube) from above the plate 20 through the larger portions 21B of the openings 21. The size of the larger portions 21B of the openings 21 is such that larger than that of the sampling device so that the sampling device may easily be inserted through the openings 21 without interference between the sides of the opening and the sides of the sampling device. After insertion, the sampler tip is located beneath the plate 20, while a body and distal end of the sampling device are provided above the plate 20 (see, for example, FIG. 4B). Because the sampler tip is larger than the notched portion 21A of the non-circular openings 21, the notched portion 21A may be used to facilitate separation of the sampler tip from the sampling device, as discussed in further detail below. For example, once the sampling device has been inserted through the opening, it may be moved laterally into the notched portion 21A, which is smaller than the sampler tip. When the sampling device is then moved upward out of the opening (e.g., retracted from the opening), the sampler tip will detach from the body of the sampling device due to the engagement of at least a portion of the sampler tip with the portion of the plate surrounding the smaller notched portion of the opening.

Handling of the sampling devices can be automated using a commercially available automated sample handler (e.g., which includes 20-200 microliter pipette heads). According to an exemplary embodiment, the distal end of the sampling device is configured for use with (e.g., will fit) a standard 20-200 microliter pipette head. The automated sample handler may be programmed to pick up the sampling devices via the pipette head and to insert the sampling devices into the sample rack 10 at a desired location. The automated sample handler may also be configured to move the sample devices laterally within the sample rack 10 such that the sampler tips are at least partially located in the notched portions 21A of the openings 21. Once the sampler tips are located in the notched portions 21A, the automated sample handler may move the sampling devices vertically out of the plate 20. As the sampling devices are lifted, the sampler tip cannot fit through the notched portions 21A, which is smaller than the larger portions 21B of the non-circular openings 21. Because the sampler tips cannot pass through the notched portions 21A, the sampler tips will be separated from the sampling device and will remain in the sample rack 10. Thus, using the plate 20 having non-circular openings 21, the sampler tip removal process may be automated. The automated sample holder can be used to move a plurality of sampling devices simultaneously or sequentially.

The plate 20 may be removed prior to performing a process for extracting the sample, or the plate 20 may remain in place while an extraction buffer or water is added to the wells of the sample rack 10.

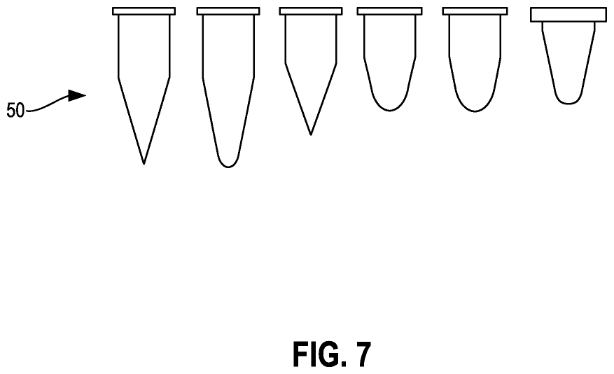

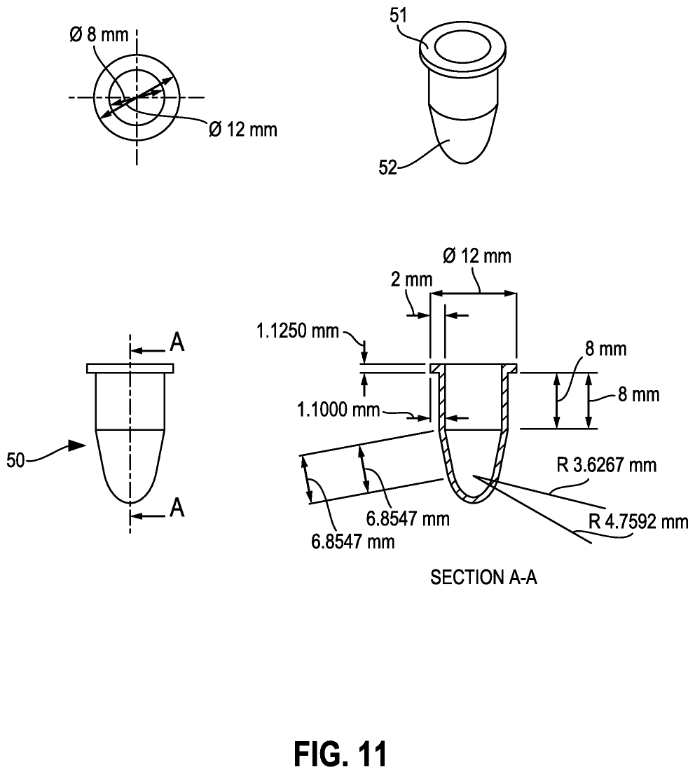

Referring now to FIGS. 7-12, in applications in which a sampling apparatus is used to process microsamples (biological samples having a small volume of 100 microliters or less, in particular, 10 microliters, 20 microliters, 30 microliters etc.), a microcentrifuge vial 50 may be used. For example, a microcentrifuge vial 50 may be coupled to a standard size test tube (e.g., 12 mm×75 mm) or a similar type of device, such as a sample vial, so as to receive a small volume of a biological sample. One microcentrifuge vial 50 may be inserted into each test tube according to an exemplary embodiment. The microcentrifuge vial 50 has a length less than the length of the test tube or other device into which it is inserted. Use of the microcentrifuge vial 50 ensures that the biological sample is compatible with existing lab equipment and can be more easily extracted, as will be described in further detail below.

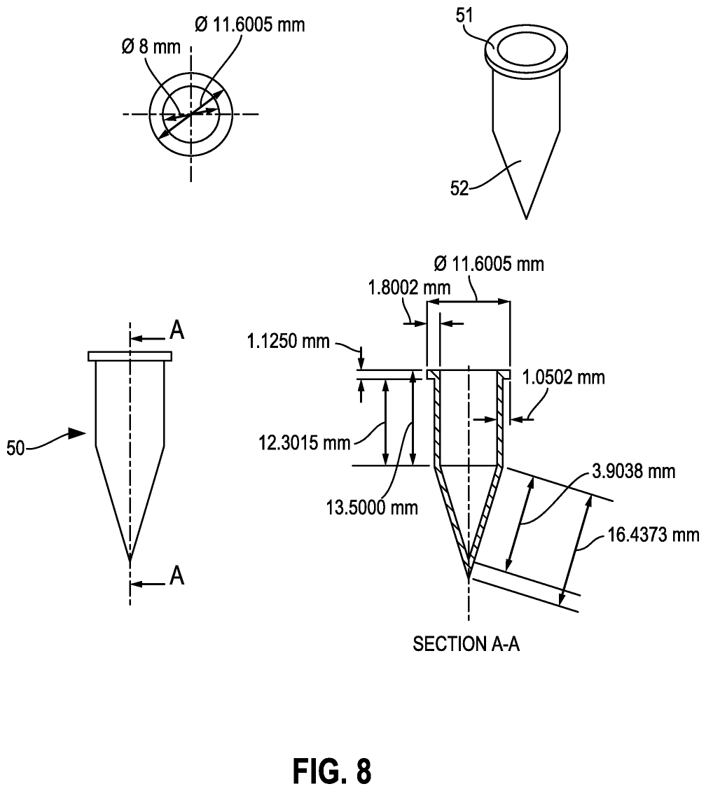

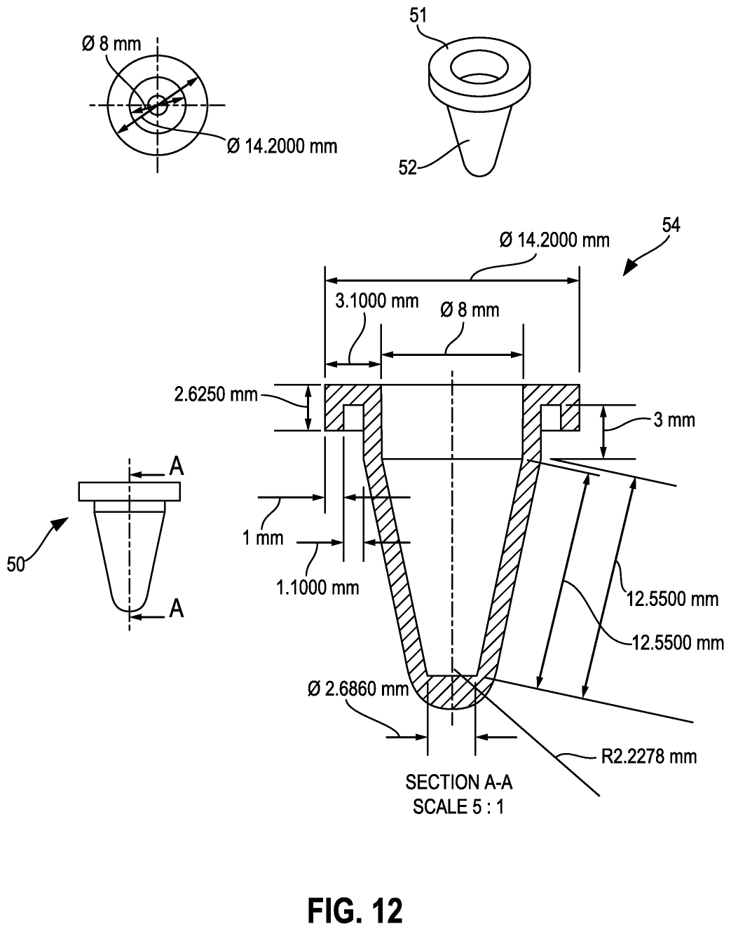

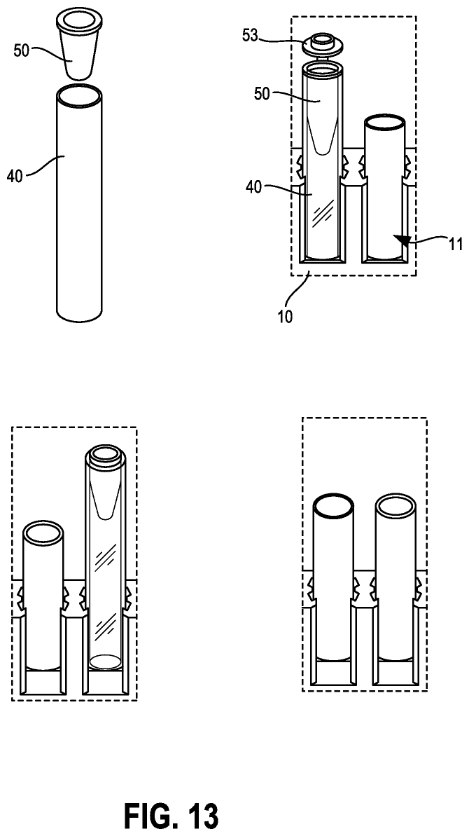

The microcentrifuge vial 50 is hollow and includes a base 51 (e.g., shown as an annular rim or lip) and a protrusion 52 (e.g., a cup, receptacle, etc.) that extends downward from the base 51. Referring to FIGS. 8-11, the microcentrifuge vial 50 may function as a stopper that seals the test tube or vial via a friction fit (for ease of reference, the device will be discussed below as a test tube, but it should be understood that other similar devices may also be used according to other exemplary embodiments). The base 51 rests upon an upper surface of the test tube (without receiving the upper surface of the test tube therein). Referring to FIG. 12, in some examples, the microcentrifuge vial 50 may include an extension that defines a channel 54 formed in a lower surface of the base 51. The channel 54 is configured to receive the upper surface of the test tube when the microcentrifuge vial 50 is fitted within the test tube, thereby acting to more securely attach (e.g., lock) the microcentrifuge vial 50 to the test tube. In other examples, the microcentrifuge vial 50 may include a lid 53 (see FIG. 13) that can be repeatedly and reversibly opened and closed.

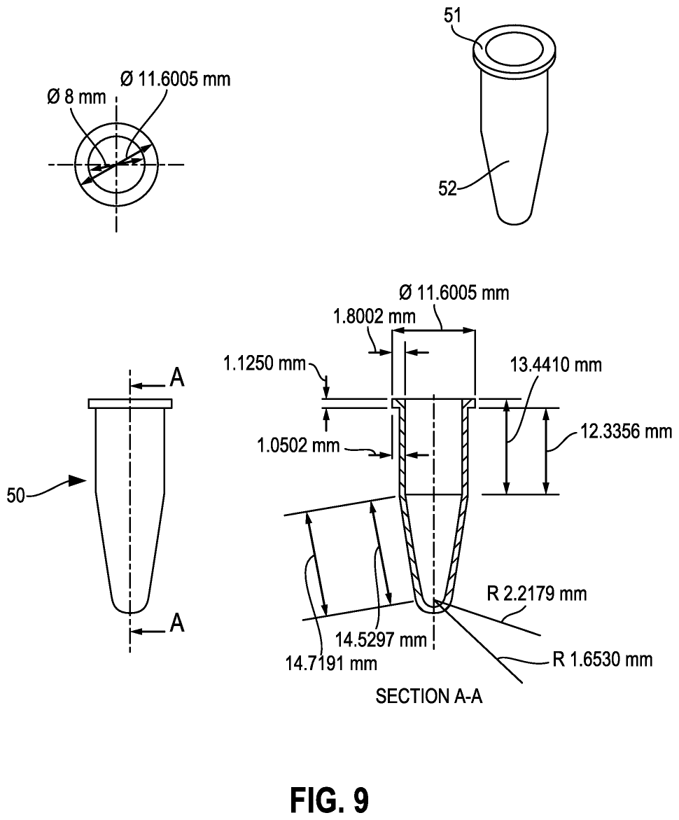

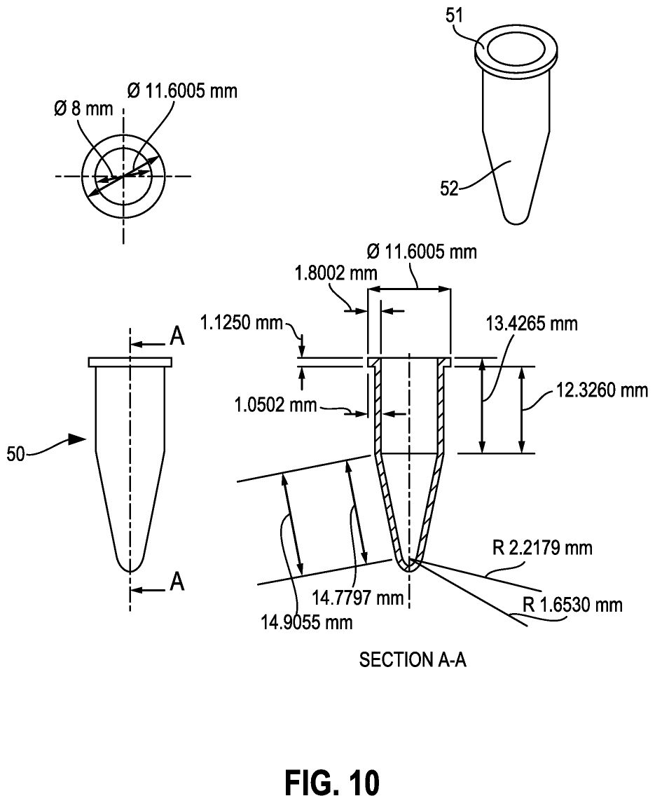

The microcentrifuge vial 50 may be manufactured using any suitable process, including via additive manufacturing (e.g., 3D printing). The microcentrifuge vial 50 may be produced in a variety of shapes and sizes configured to be compatible with the type of microsampling device selected or the lab equipment being used. FIGS. 7-13 illustrate various non-limiting examples of the shapes and sizes of the microcentrifuge vial 50. In various examples, the protrusion 52 may have a rounded end, a pointed end, or a frusto-conical end. The walls of the protrusion 52 may include a vertical portion and an inclined portion (see FIGS. 8-11), or the walls of the protrusion 52 may only include an inclined portion (see FIG. 12). The walls of the protrusion 52 may be inclined at a shallow or steep slope (compare FIG. 9 to FIG. 10). The length of the protrusion 52 may differ according to various embodiments (compare FIG. 9 to FIG. 11).

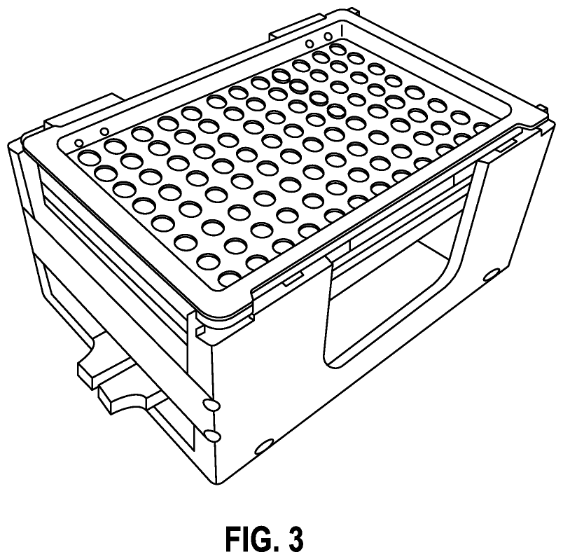

The microcentrifuge vial 50 may be used in a sampling apparatus including the sample rack 10 and the plate 20 described above. Alternatively, the microcentrifuge vial 50 may be used in a sampling apparatus including the sample rack 10 and plate having circular openings (see, e.g., FIG. 3). The microcentrifuge vial 50 may also be used with a microsampler such as the Mitra® microsampler that obtains a biological sample of 100 microliters or less. The sampler tip in which the biological sample is absorbed is inserted within the microcentrifuge vial 50. The sampler tip can be separated from the microsampler and inserted into the microcentrifuge vial 50 using the automated separation method described above, or the sampler tip can be manually separated from the microsampler and inserted into the microcentrifuge vial 50. In some examples, the sampler tip is separated from the microsampler prior to extracting the sample. In such cases, the sampler tip may be submerged in an extraction buffer or water provided in the microcentrifuge vial 50.

The microcentrifuge vial 50 containing the sampler tip and the extraction buffer or water therein can be removed from the test tube and placed in a centrifuge by itself, or the microcentrifuge vial 50 containing the sampler tip and the extraction buffer or water therein can be placed in a centrifuge while still attached to the test tube. The centrifuge is used to extract the sample from the sampler tip. The biological sample may be, for example, blood, urine, tears, saliva, sweat, serum, cerebral spinal fluid (CSF), plasma, or synovial fluid (although other types of samples can be used in accordance with other exemplary embodiments). The microsampler may be used in conjunction with the microcentrifuge vial 50 and the test tube, but is not necessarily part of the microsampling apparatus.

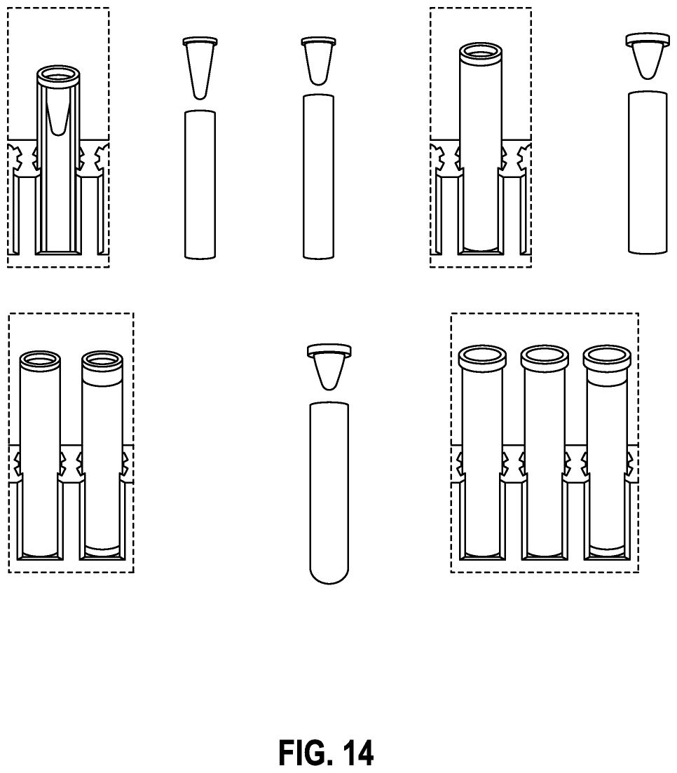

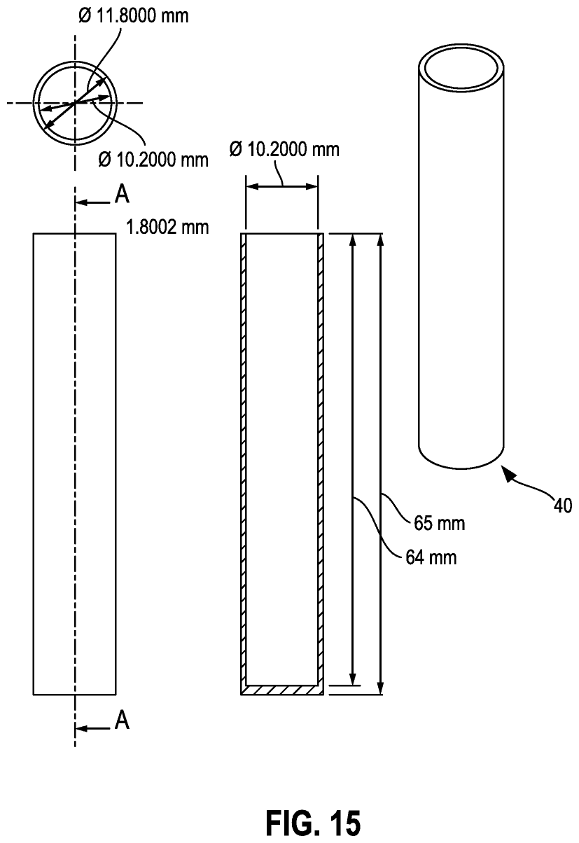

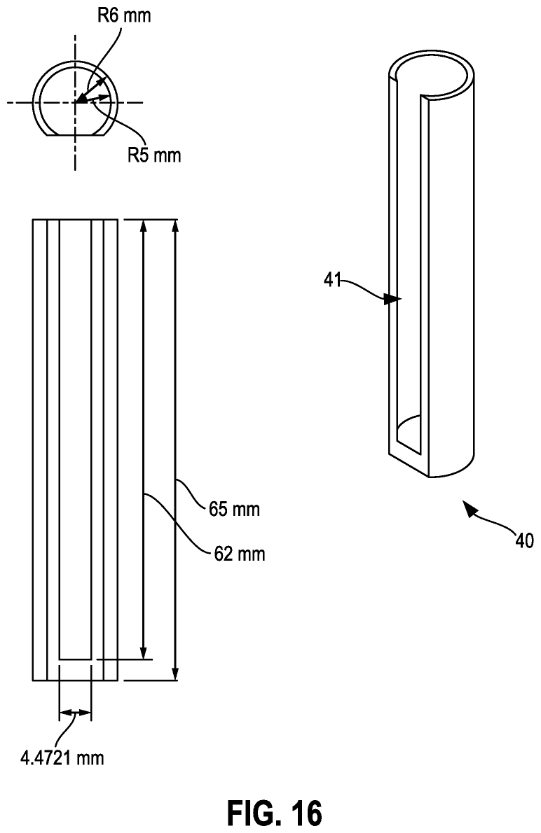

If desired, instead of using a standard size test tube, the microcentrifuge vial 50 can be fitted to a custom tubular casing 40. In some examples, the tubular casing 40 is a hollow, cylindrical shell that is open on one end thereof in order to receive the microcentrifuge vial 50 (see FIG. 15). The tubular casing 40 can be designed to mimic the size of a standard test tube such that the tubular casing 40 will fit in the rack 10. In other examples, the tubular casing 40 may be a hollow, cylindrical shell having that is open on one end thereof and has a slice removed therefrom such that a rectangular aperture 41 is formed in the tubular casing 40 (see FIG. 16). In some examples, the rectangular aperture 41 allows a user to view the inside of the tubular casing 40 (see upper left of FIG. 14) or to scan a barcode provided on the microsampler. The barcode may be scanned to identify information regarding the biological sample such as the source, the type of biological sample, the date the biological sample was collected, a patient name or identification number, the analytes to be analyzed, etc.

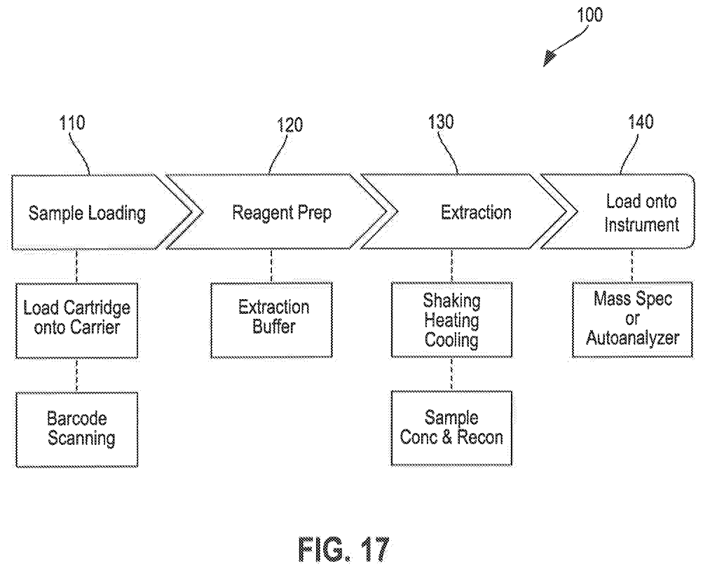

Referring to FIG. 17, a method 100 of using the microsampling apparatus to analyze a biological sample will now be described. In a step 110, the samples are loaded, during which a cartridge is loaded onto a carrier and an associated barcode may be scanned. During the loading operation, one or more tubular casings 40 (or test tubes according to other embodiments) are provided in the sample rack 10. One microcentrifuge vial 50 is inserted into each of the test tubes or tubular casings 40. A plate (e.g., the plate 20 or a plate having circular openings) is fixed to the sample rack 10. One or more microsamplers, each containing the biological sample in the sampler tip thereof, is inserted into the microsampling apparatus (one microsampler in each of the test tubes or tubular casings 40) such that the sampler tip of the microsampler is provided within a respective microcentrifuge vial 50 beneath the plate. A barcode affixed to the microsampler or to the test tube or tubular casing 40 may be read to acquire sample information. The microsampler is then removed from the microsampling apparatus (in an automated process) or the sampler tip is separated from the microsampler manually. The separated sampler tip is provided within the microcentrifuge vial 50.

In a step 120, each of the microcentrifuge vials 50 may be pre-loaded with an extraction buffer or water prior to the sampler tip being inserted into the microcentrifuge vial 50, or an extraction buffer or water may be added to the microcentrifuge vial 50 with the sampler tip already present therein. Removing the sampler tips and then submerging them in the extraction buffer or water prior to performing a sample extraction process increases analyte recovery. The microsampling apparatus may then undergo a sample extraction process in a step 130, which includes one or more known extraction methods such as shaking, heating, or cooling. In some examples, the sample may optionally be dried down under nitrogen and/or reconstituted. The microsampling apparatus is then loaded in a step 140 onto an instrument such as a mass spectrometer or an autoanalyzer (e.g., an Abbott Architect and Beckman-Coulter AU autoanalyzer) to analyze the desired properties of the sample.

Because each of the components of the microsampling apparatus may be 3D printed, material costs are significantly reduced. The microsampling apparatus allows for automated chemistry and sample extraction, and is compatible with various microsamplers and automated sample handler systems.

One versed in the art would appreciate that there may be other embodiments and modifications within the scope and spirit of the disclosure. Accordingly, all modifications attainable by one versed in the art from the present disclosure, within its scope and spirit, are to be included as further embodiments of the present disclosure. Any dimensions included in the accompanying drawings are representative only and are not to be considered defining or limiting in any way, as many variations may be possible.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the components as shown in the various exemplary embodiments is illustrative only. Additionally, any element disclosed in one embodiment may be incorporated or utilized with any other embodiment disclosed herein. For example, the extension shown in the microcentrifuge vial of FIG. 12 may be used in conjunction with any of the others microcentrifuge vials shown and discussed. Although only one example of an element from one embodiment that can be incorporated or utilized in another embodiment has been described above, it should be appreciated that other elements of the various embodiments may be incorporated or utilized with any of the other embodiments disclosed herein.

1. An apparatus for use in biological sampling, the apparatus comprising:
a plate configured for attachment to a sample rack, the plate comprising a plurality of openings extending therethrough, wherein the plurality of openings each have a non-circular shape that comprises a first portion and a second portion, the first portion having a smaller lateral dimension than the second portion.

2. The apparatus of claim 1, wherein each of the plurality of openings has a teardrop shape.

3. The apparatus of claim 1, wherein each of the plurality of openings has a keyhole shape.

4. The apparatus of claim 1, wherein the first portion is a notched portion.

5. The apparatus of claim 1, wherein each of the plurality of openings is configured to receive a sampling device therethrough and the first portion is configured to allow for separation of a sampler tip from the sampling device.

6. The apparatus of claim 5, wherein the sampling device is a microsampling specimen collection device.

7. The apparatus of claim 1, further comprising a sample rack, wherein the plate is coupled to the sample rack.

8. The apparatus of claim 7, wherein the sample rack is configured to hold a plurality of test tubes that are aligned with the plurality of openings in the plate.

9. The apparatus of claim 7, further comprising a microcentrifuge vial that comprises a base and a protrusion extending from the base, wherein the base is configured for securing the microcentrifuge vial to a test tube.

10. The apparatus of claim 9, further comprising an extension that extends from the base that defines a channel in which an upper end of a test tube may be received to aid in securing the microcentrifuge vial to the test tube.

11. The apparatus of claim 9, wherein the protrusion is hollow and is configured to receive a biological sample.

12. The apparatus of claim 1, wherein has an end that is rounded, pointed, or frusto-conical.

13. A method of extracting a biological sample from a sampling device using an apparatus as recited any of the preceding claims, wherein the method comprises:
inserting at least a portion of a sampling device containing a biological sample through one of the plurality of openings in the plate, the sampling device comprising a sampler body and a sampler tip, wherein the sampler tip is beneath the plate following the insertion;
moving the sampling device laterally toward the first portion of the opening; and
retracting the sampler body out of the opening to separate the sampler tip from the sampler body.

14. The method of claim 13, wherein retracting the sampler body out of the opening causes at least a portion of the sampler tip to engage with the plate surrounding the first portion of the opening to cause separation of the sampler tip from the sampler body.

15. The method of claim 13, further comprising simultaneously performing the steps of the method for a plurality of sampling devices using an automated sample handler.
